(19) United States
(12) Patent Application Publication
(10) Pub. No.: US 2008/0030126 A1
(43) Pub. Date: Feb. 7, 2008

(54) Thin, durable electroluminescent lamp

(75) Inventors: William F. Scholz, Scottsdale, AZ (US); David G. Pires, Phoenix, AZ (US)

Correspondence Address: Paul F. Wille;Cantor Colburn LLP, 55 Griffin Road South, Bloomfield, CT, 06002, US

(73) Assignee: World Properties, Inc., Lincolnwood, IL (US)

(21) Appl. No.: 11/485,131

(22) Filed: Jul. 12, 2006

(51) Int. Cl. H05B 33/00; H05B 33/26

(52) U.S. Cl. 313/503; 313/506; 313/502

(57) ABSTRACT

A high brightness, durable, thick film electroluminescent lamp includes a base having a thin layer of PET on a release layer and a transparent front electrode of ITO particles in a resin, a transparent rear electrode, and a reflective layer overlying the transparent rear electrode.

### CROSS-REFERENCE TO RELATED APPLICATION

This application relates to application Ser. No. 10/790,978, filed Mar. 2, 2004, entitled Dimensionally Stable EL Lamp without Substrate, and assigned to the assignee of this invention. The entire contents of said application are incorporated by reference into this application.

### BACKGROUND OF THE INVENTION

This invention relates to a thin, thick-film, inorganic, electroluminescent (EL) panel and, in particular, to an EL panel assembled on a release layer and, after separation from the release layer, is difficult to tear or distort and, when lit, is brighter than EL lamps of the prior art.

As used herein, and as understood by those of skill in the art, “thick-film” refers to one type of EL lamp and “thin-film” refers to another type of EL lamp. The terms only broadly relate to actual thickness and actually identify distinct disciplines. In general, thin film EL lamps are made by vacuum deposition of the various layers, usually on a glass substrate or on a preceding layer. Thick-film EL lamps are generally made by depositing layers of inks on a substrate, e.g. by roll coating, spraying, or various printing techniques. The techniques for depositing ink are not exclusive, although the several lamp layers are typically deposited in the same manner, e.g. by screen printing. A thin, thick-film EL lamp is not a contradiction in terms and such a lamp is considerably thicker than a thin film EL lamp.

In the context of a thick-film EL lamp, and as understood by those of skill in the art, “inorganic” refers to a crystalline, luminescent material that does not contain silicon or gallium. The term does not refer to the other materials from which an EL lamp is made.

As used herein, an EL “panel” is a single sheet including one or more luminous areas, wherein each luminous area is an EL “lamp.” An EL lamp is essentially a capacitor having a dielectric layer between two conductive electrodes, one of which is transparent. The dielectric layer can include phosphor particles or there can be a separate layer of phosphor particles adjacent the dielectric layer. The phosphor particles radiate light in the presence of a strong electric field, using relatively little current.

EL phosphor particles are typically zinc sulfide-based materials, including one or more compounds such as copper sulfide (Cu₂S), zinc selenide (ZnSe), and cadmium sulfide (CdS) in solid solution within the zinc sulfide crystal structure or as second phases or domains within the particle structure. EL phosphors typically contain moderate amounts of other materials such as dopants, e.g., bromine, chlorine, manganese, silver, etc., as color centers, as activators, or to modify defects in the particle lattice to modify properties of the phosphor as desired. The color of the emitted light is determined by the doping levels. Although understood in principle, the luminance of an EL phosphor particle is not understood in detail. The luminance of the phosphor degrades with time and usage, more so if the phosphor is exposed to moisture or high frequency (greater than 1,000 hertz) alternating current.

Various colors can be produced by mixing phosphors having different dopants or by “color cascading” phosphors. A copper-activated zinc sulfide phosphor produces blue and green light under an applied electric field and a copper/manganese-activated zinc sulfide produces orange light under an applied electric field. Together, the phosphors produce what appears to be white light. It has long been known in the art to color-cascade phosphors, i.e. to use the light emitted by one phosphor to stimulate another phosphor or other material to emit light at a longer wavelength; e.g. see U.S. Pat. No. 3,052,810 (Mash). It is also known to doubly cascade light-emitting materials. U.S. Pat. No. 6,023,371 (Onitsuka et al.) discloses an EL lamp that emits blue light coated with a layer containing fluorescent dye and fluorescent pigment. In one example, the pigment absorbs blue light and emits green light, while the dye absorbs green light and emits red light.

Water vapor or water molecules can be very detrimental to phosphor. Environmental stability of the phosphor can be improved by coating the phosphor particles. For example, U.S. Pat. No. 5,220,243 (Klinedinst et al.) discloses coating zinc sulphide particles with a coating derived from trimethylaluminum (TMA). U.S. Pat. No. 5,958,591 (Budd) discloses a coating including aluminum oxide and the oxide of another metal, such as silicon or titanium (Si/Ti).

A modern (post-1985) EL lamp typically includes transparent substrate of polyester or polycarbonate material having a thickness of about 7.0 mils (0.178 mm.). A transparent, front electrode of indium tin oxide or indium oxide is vacuum deposited onto the substrate to a thickness of 1000 A° or so. A phosphor layer is screen printed over the front electrode and a dielectric layer is screen printed over phosphor layer. A rear electrode is screen printed over the dielectric layer. It is also known in the art to deposit the layers by roll coating.

The inks used include a binder, a solvent, and a filler, wherein the filler determines the nature of the ink. A typical solvent is dimethylacetamide (DMAC). The binder is typically a fluoropolymer such as polyvinylidene fluoride/hexafluoropropylene (PVDF/HFP), polyester, vinyl, epoxy, or Kynar 9301, a proprietary terpolymer sold by Atofina. A phosphor layer is typically screen printed from a slurry containing a solvent, a binder, and zinc sulphide particles. A dielectric layer is typically screen printed from a slurry containing a solvent, a binder, and particles of titania (TiO₂) or barium titanate (BaTiO₃). A rear (opaque) electrode is typically screen printed from a slurry containing a solvent, a binder, and conductive particles such as silver or carbon.

As long known in the art, having the solvent and binder for each layer be chemically the same or chemically similar provides chemical compatibility and good adhesion between adjacent layers; e.g., see U.S. Pat. No. 4,816,717 (Harper et al.). It is not easy to find chemically compatible phosphors, dyes, binders, fillers, solvents or carriers and to produce, after curing, the desired physical properties, such as flexibility, and the desired optical properties, such as color and brightness.

It is known in the art to add a reflective layer to increase brightness. For example, U.S. Pat. No. 3,007,070 (Cargill) discloses a layer of BaTiO₃ underneath an EL phosphor layer for increasing the brightness of the lamp.

An EL lamp constructed in accordance with much of the prior art is relatively thick, even though it is typically only seven mils thick, making the lamp unsuited to some applications requiring greater flexibility. Relatively thin EL lamps are known in the art. For example, U.S. Pat. No. 5,856,030 (Burrows) discloses an EL lamp made on a UV-cured urethane layer on a release paper. The release paper provides substantial structural support while the lamp layers are applied from an ink containing a vinyl gel. Unlike panels made on substrates that are seven mils thick, or so, EL panels made on thin sheets from flexible materials, e.g. urethane one to five mils thick, are easily torn or distorted This makes it extremely difficult to automate the assembly of panels into end products, e.g. backlighting for a display or as the luminous structure in a three dimensional molded object.

In the market for EL lamps, there is a continuing demand for higher brightness and lower cost. What are taken as givens are environmental stability (can endure high temperature and high humidity or low temperature) and electrical stability (tolerant of at least some DC bias, which tends to cause ionic migration). Such a market is a moving target and difficult to satisfy.

In view of the foregoing, it is therefore an object of the invention to provide a thin, thick-film, inorganic EL lamp that is durable, not easily torn or distorted.

Another object of the invention to provide a thin, thick-film, inorganic EL lamp that is brighter than EL lamps of the prior art.

A further object of the invention is to provide a thin, thick-film, inorganic EL panel that is tolerant of DC bias.

Another object of the invention is to provide a thin, thick-film, inorganic EL panel that is environmentally stable.

A further object of the invention is to provide a thin, thick-film, inorganic EL panel that meets the foregoing objects simultaneously.

### SUMMARY OF THE INVENTION

The foregoing objects are achieved in this invention in which a durable, thin, thick-film, inorganic, electroluminescent lamp includes a base having a thin layer of PET on a release layer and a transparent front electrode of ITO particles in a resin, a transparent rear electrode, and a reflective layer overlying the transparent rear electrode.

### BRIEF DESCRIPTION OF THE DRAWINGS

A more complete understanding of the invention can be obtained by considering the following detailed description in conjunction with the accompanying drawings, in which:

FIG. 1 is a cross-section of an EL lamp constructed in accordance with the prior art;

FIG. 2 is a cross-section of another EL lamp constructed in accordance with the prior art;

FIG. 3 is a cross-section of an EL lamp constructed in accordance with a preferred embodiment of the invention;

FIG. 4 is a cross-section of an EL lamp constructed in accordance with an alternative embodiment of the invention; and

FIG. 5 is a chart of the results of tests.

### DETAILED DESCRIPTION OF THE INVENTION

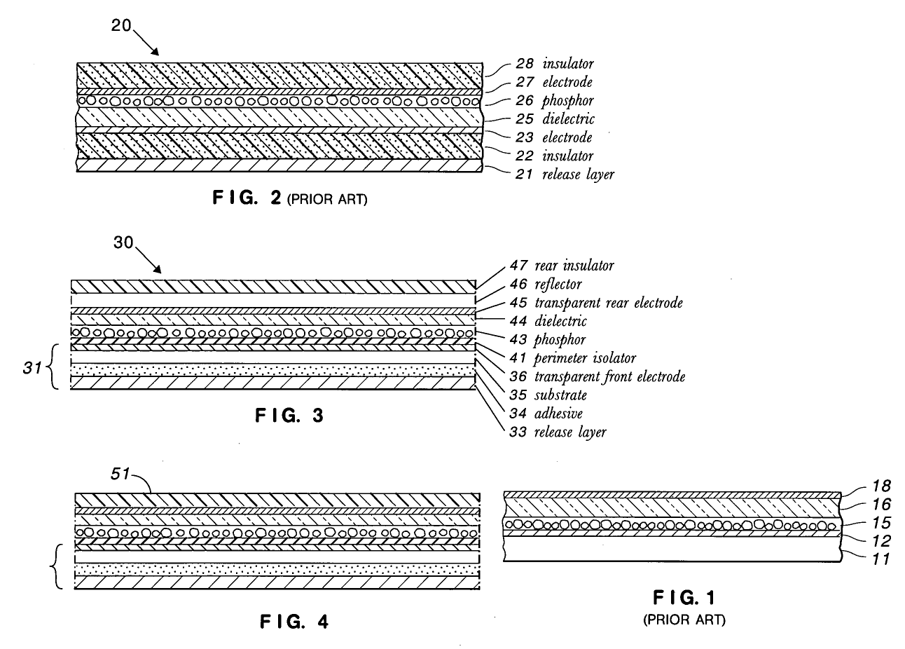

The lamp illustrated in FIG. 1 is a standard (self-supporting) EL lamp known in the art and is used for comparison with lamps made in accordance with the invention. The lamp illustrated in FIG. 2, referred to as a “DFLX” lamp, is also used for comparison with other lamps described herein. None of the figures are drawn to scale, either within a figure or between figures.

In FIG. 1, transparent substrate 11 is a sheet of bi-axially oriented plastic such as polyester or polycarbonate, 5-7 mils thick. Transparent front electrode 12 overlies substrate 11 and is a thin layer of indium tin oxide or indium oxide. The transparent electrode is sputter deposited and the substrate with electrode are commercially available. Phosphor layer 15 overlies the front electrode and dielectric layer 16 overlies the phosphor layer. Layers 15 and 16 are combined in some applications. Overlying dielectric layer 16 is opaque rear electrode 18. An optional backing layer (not shown) may also be provided, e.g. for insulating the rear electrode. Coated phosphor particles are used, eliminating the need for a sealing layer.

Dielectric layer 16 can be made with particles of titania (TiO₂) barium titanate (BaTiO₃) in a suitable resin ink. A lamp type known as “HBC” sold by Durel Division of Rogers Corporation uses barium titanate as the dielectric and that is the designation herein for a lamp constructed as shown in FIG. 1.

FIG. 2 is a cross-section of an EL lamp constructed as described in the above-identified copending application. Lamp 20 includes release layer 21 with insulating layer 22 deposited thereon, e.g. by screen printing or other technique known in the art. The release layer is a coated paper or a plastic sheet, such as polyethylene terephthalate (PET), supplied in rolls, which facilitates handling the lamps and integrating the lamps into appliances or molding apparatus.

Electrode 23 is carbon bearing, conductive polymer that is screen printed on layer 22. Dielectric layer 25 overlies electrode 23 and phosphor layer 26 overlies the dielectric layer. Electrode 27 is made by screen printing a transparent conductive layer containing PEDOT (poly-3,4-ethylenedioxythiophene), such as available from Bayer or Agfa, on phosphor layer 26. Insulating layer 28 overlies electrode 27.

FIG. 3 is a cross-section of a lamp constructed in accordance with a preferred embodiment of the invention. Lamp 30 includes base 31, a conductive sheet commercially available from Sumitomo Metal Mining (SMM). Base 31 includes release layer 33, adhesive layer 34, substrate 35, and transparent front electrode 36.

Release layer 33 is 100μ PET. Adhesive layer 34 is a UV cured acrylic. Substrate 35 is a 6μ-50μ thick layer of PET, preferably having a thickness of 12μ-1μ. Electrode 36 is made with very fine (300-500 nm) particles (“nano particles”) of ITO in a UV cured resin. The PET substrate is dimensionally stable despite its relative thinness. Other stable substrates can be used instead.

The remaining layers of lamp 30 include insulating layer 41 around the perimeter of the lamp to prevent shorting along the edges, phosphor layer 43, dielectric layer 44, transparent rear electrode 45, reflective layer 46, and rear insulator 47. In FIG. 4, the alternative embodiment differs from FIG. 3 in that layers 46 and 47 are combined in layer 51.

Reflective layer 46 is not between the electrodes and does not affect the electrical operation of the lamp, which is sensitive to dielectric constant, susceptibility, and electrode spacing. Also because reflective layer 46 is not between the electrodes, one can choose a reflective layer for optical performance rather than for electrical performance. A layer having a reflectance of ninety percent or greater is preferred and the choice of materials is considerable. For example, of the materials specifically mentioned herein, layers containing barium titanate or titanium dioxide, each have a reflectance greater than ninety percent. The dielectric layer can be made thinner, which aids brightness, because one does not have to reflect all incident light with this layer.

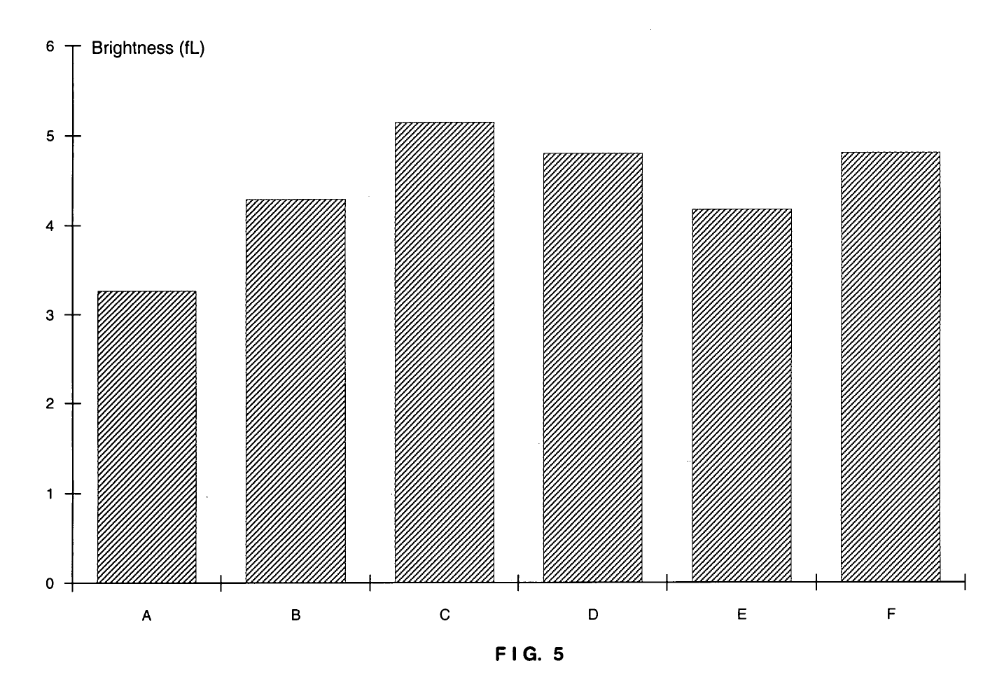

FIG. 5 is a bar chart of the results of testing several of each type of sample. Each bar is an average of the results for the particular sample. Sample “A” is the present “DFLX” construction. This is a lamp that is not self-supporting and is subject to mechanical distortion. Sample “E” is a commercially available lamp. Sample “E” is much thicker than sample “A” and is much less flexible but is mechanically stable and slightly brighter than sample “A.” These lamps are representative of the state of the art in commercially available EL lamps.

For the tests, all lamps had the same shape and area. Each lamp was driven by the same inverter from a three volt supply. The phosphor used was the same in all samples and the dielectric layer was the same in all samples. A reflector behind a transparent rear electrode substantially improved brightness in otherwise identical constructions. The base provides a much more dimensionally stable lamp, while also improving brightness.

In the following chart, “a-ITO” refers to acicular ITO and “s-ITO” refers to sputtered ITO. Acicular ITO is as a transparent conductor known in the art, see U.S. Pat. No. 5,580,496 (Yukinobu et al.), having ITO needles suspended in an organic resin.

| | | substrate | front electrode | rear electrode | reflector |
|---|---|---|---|---|---|
| A | DFLX | polyurethane | Orgacon | Carbon | none |
| B | | SMM | N/A | Carbon | none |
| C | | SMM | N/A | PEDOT | TiO2 |
| D | | SMM | N/A | a-ITO | TiO2 |
| E | HBC | PET | s/ITO | Carbon | none |
| F | modified | PET | s/ITO | PEDOT | TiO2 |
| | HBC | | | | |

The invention thus provides a thin, thick-film, inorganic EL lamp that is not easily torn or distorted, is brighter than EL lamps of the prior art and is as environmentally stable as commercially available lamps.

Having thus described the invention, it will be apparent to those of skill in the art that various modifications can be made within the scope of the invention. For example, the phosphor layer can be divided into areas for containing phosphors producing different colors instead of or in addition to the cascading layer. More than one cascading layer can be used, e.g. by including dye in the front insulating layer. As illustrated in FIG. 1, lamp 20 is constructed back to front. Typically, building an EL lamp from front to back involves no more than reversing the order in which layers are deposited. Unless indicated otherwise, it is immaterial which way the lamp is assembled when constructing a lamp in accordance with the invention. Other layers could be added to the embodiment shown in FIG. 1, such as graphic overlays and protective layers. Any layer can be split to form a plurality of lamps in a single panel.

What is claimed as the invention is:

1. A durable, thin, thick-film, inorganic, electroluminescent lamp comprising:
a transparent front electrode;
a phosphor layer overlying said front electrode;
a dielectric layer overlying said phosphor layer;
a transparent rear electrode overlying said dielectric layer; and
a reflective layer overlying the transparent rear electrode.

2. The lamp as set forth in claim 1 wherein said transparent front electrode is a layer including indium tin oxide.

3. The lamp as set forth in claim 1 wherein said transparent front electrode is a base having a transparent conductive layer including particles of indium tin oxide in a resin.

4. The lamp as set forth in claim 1 wherein said transparent rear electrode includes poly-3,4-ethylenedioxythiophene.

5. The lamp as set forth in claim 1 wherein said transparent rear electrode includes indium tin oxide.

6. The lamp as set forth in claim 1 wherein said reflective layer has a reflectance greater than ninety percent.

7. The lamp as set forth in claim 1 wherein said reflective layer consists essentially of titanium dioxide in a polymer binder.

8. The lamp as set forth in claim 1 wherein said transparent front electrode includes:
a substrate containing polyethylene terephthalate and having a thickness of 6μ-50μ;
a layer of resin containing particles of indium tin oxide.

9. The lamp as set forth in claim 8 wherein said layer of resin contains nano particles of indium tin oxide.

10. A high brightness, durable, thick film electroluminescent lamp comprising:
a transparent front electrode, wherein said transparent front electrode includes a layer of resin containing particles of indium tin oxide;
a phosphor layer overlying said front electrode;
a dielectric layer overlying said phosphor layer;
a transparent rear electrode overlying said dielectric layer; and
a reflective layer overlying the transparent rear electrode and consisting essentially of titanium dioxide in a polymer binder.

11. The lamp as set forth in claim 10 wherein said transparent rear electrode includes poly-3,4-ethylenedioxythiophene.

12. The lamp as set forth in claim 10 wherein said transparent rear electrode includes acicular indium tin oxide.

13. The lamp as set forth in claim 10 wherein said transparent front electrode includes:
a thin substrate containing polyethylene terephthalate; and
said layer of said resin containing particles of indium tin oxide overlies said substrate.

14. The lamp as set forth in claim 13 wherein said particles of indium tin oxide are nano particles.

15. A high brightness, durable, thick film electroluminescent lamp comprising:
a transparent front electrode including a substrate containing polyethylene terephthalate and a layer of resin containing nano particles of indium tin oxide;
a phosphor layer overlying said front electrode;
a dielectric layer overlying said phosphor layer;
a transparent rear electrode overlying said dielectric layer; and
a reflective layer overlying the transparent rear electrode and having a reflectance of greater than ninety percent.

16. The lamp as set forth in claim 15 wherein said transparent rear electrode includes poly-3,4-ethylenedioxythiophene.

17. The lamp as set forth in claim 15 wherein said transparent rear electrode includes acicular indium tin oxide.
